(19) United States
(12) Patent Application Publication
(10) Pub. No.: US 2006/0150545 A1
(43) Pub. Date: Jul. 13, 2006

(54) Structural assembly for sliding doors which can be recessed into the wall of a building

(75) Inventors: Massimo Migliorini, Rimini (IT); Livio Serafini, Rimini (IT)

Correspondence Address: PEARNE & GORDON LLP, 1801 EAST 9TH STREET, SUITE 1200, CLEVELAND, OH, 44114-3108, US

(73) Assignees: KRONA I S.p.A.; SISTEMI GLOBALI S.r.l.

(21) Appl. No.: 11/328,548

(22) Filed: Jan. 10, 2006

(30) Foreign Application Priority Data
Jan. 13, 2005 (IT) RN2005A000001

(51) Int. Cl. E06B 1/04

(52) U.S. Cl. 52/204.1

(57) ABSTRACT

A structural assembly (1) for sliding doors (12) which can be recessed into a structural casing (3; 59) contained in a building wall (30) comprises uprights (4; 64) which can be connected to an entrance opening (25) of the casing (3; 59), the uprights having section bars (5; 65) for connecting finishing elements (33) to coverings (24; 60; 23) of a casing (3; 59) wall element (2). The section bars (5; 65) have a multi-sided outer surface, with tabs (6; 56; 7; 57). A first tab (6; 56) can be connected to a face of the wall element (2) facing towards the inside of the casing (3; 59). The second tab (7; 57) projects transversally to the plane in which the door (12) slides, parallel with an end surface (9) of the coverings (24; 60; 23) of the wall element (2), remaining confined inside the outer edge (26; 62) of the building wall (30). The uprights (4; 64) can be connected both to the section bars (5; 65) and to part of the end surface (9) of the covering (24; 60; 23) with which they are in direct contact.

### BACKGROUND OF THE INVENTION

The present invention relates to a structural assembly made up of elements for sliding doors which can be recessed into the wall of a building.

More particularly, the structural assembly is designed to be fitted on the door supporting and containment structure.

Technology for the construction of sliding doors which can be recessed into the walls of buildings already provides construction solutions for the door supporting and containment structures which basically use two specific ideas.

A first type solution sees the door enclosed in a self-supporting metal casing, made of steel or aluminium, housed in the wall of the building. The casing has two extended wall elements, with flat faces, parallel with the plane in which the door lies, which are fitted with a welded mesh for anchoring an exterior covering plaster that forms part of the wall element.

Inside the casing there is a horizontal track which, running longitudinally with it, supports the bottom of the door hung and allows the door to move in the guide away from and towards the casing.

The track is supported by two vertical uprights. One of the uprights virtually consists of the overall structure of the casing. The other upright, with which the door makes contact when it has completely exited the casing, consists of a beam normally made of wood, vertical, fixed to the building wall of the door compartment furthest from the casing.

The other type of construction solution involves production of the door supporting and containment casing using: a lattice comprising a frame, consisting of suitably connected metal uprights and crosspieces, and of fillings, consisting of sheets of a suitable material (for example prefabricated sheets of plasterboard) which are attached to the frame and form an integral part of the building wall.

On the entrance side of the casing made in this way and on the side which makes contact with the door there are shaped metal section bars. Two of these are on the two opposite sides of the casing entrance. A third is on the side which makes contact with the door, at the door sliding plane. An example of this type of construction solution is described in detail in E P 0751275 B1.

In both of the types of solutions described above, the uprights at the casing entrance have a substantially forked cross-section (also known as “catapult”). These are designed to connect a wooden element, interacting with a groove in it. The wooden element is also shaped so that it rigidly supports the outer finishing and covering cornices of the border of the door compartment, as well as the casing internal compartment seals.

The outer finishing cornices are needed to hide a tab of the casing section bars which, if the building wall outer covering is made of plasterboard panels, holds the panels, and which, if plaster which sets in situ is used, establishes an alignment reference, useful for forming the layer of plaster.

For reasons of symmetry, the finishing cornices are also attached both to the fixed upright of the door compartment with which the door makes contact when the door is closed, and to the horizontal crosspiece over the compartment, containing the compartment and containing the door sliding track.

The outer finishing cornices bring the disadvantage of preventing the achievement of the appearance of recessing the door into the building wall; an effect which recently is increasingly sought by architects and interior designers who intend to follow the principles of a certain minimalist architecture for interiors which rejects the presence of any accessory element that does not strictly pertain to the door and/or that is in any way extraneous to the building wall that houses it.

This architectural form includes a sliding door construction solution, already known, in which the structural casing ends with vertical entrance uprights each consisting of an aluminium section bar with folded elements having a tapered tab which projects towards the outside of the building wall and converges towards the latter's outer edge; the tab being angled so that it is transversal to the plane in which the door lies. As a result of its tapered shape, the tab has an oblique face towards an end wall of the casing which is, in turn, angled so that it is perpendicular to the plane in which the door lies.

The end walls of the casing and the opposite oblique wall of the section bar tapered tab therefore together delimit a compartment which visibly affects the outer covering of the building wall and which, once the door has been definitively installed, must be filled with material so as to join the surfaces, allowing the building wall to acquire the appearance of a continuous outer covering which is also required if the door is to be made to appear to be recessed into the building wall. In particular: if the wall is made of plasterboard, firstly the compartment must be filled with stucco then it must all be whitewashed; in brick walls the compartment must be filled with plaster (and this can be done when the entire wall is plastered).

A section bar with this structure is also present for the upright with which the door makes contact when it is completely closed, that is to say, when it is completely removed from the containment casing. In this case there is a single section bar with two tapered projections. The single section bar, together with the outer coverings of the building wall furthest from the casing, form two compartments, on either side of the building wall, which must be subject to the steps described above.

Such a section bar construction configuration brings further disadvantages. If the appearance of the door being completely recessed into the building wall is desired, the parts of section bar remaining in view, after stuccoing must be sanded, treated with a primer and painted.

The treatment which follows stuccoing (or plastering) is complex and involves times and costs which must be added to those for filling the compartments.

A further disadvantage is the fact that the difference in the thermal expansion coefficient existing between the material used to make the section bar (normally metal, and more specifically aluminium) and the building wall outer covering material (for example, plaster, plasterboard, or similar materials, covering bricks, etc.) may cause different expansions which over time cause cracks or fissures along the stuccoing or join lines.

Therefore, for all of these reasons, the apparent effect of a building wall with an outer covering that appears homogeneous and made of a single material, achieved using known technology, is complex to obtain and the source of potential problems which have the further aggravating circumstance of being able to manifest themselves even after a considerable period of time.

### SUMMARY OF THE INVENTION

The main aim of the invention is therefore to overcome said disadvantages with a solution that allows the easy, economical, rapid and reliable production of sliding doors which can be concealed by recessing them into building walls and where the outer appearance of the relative covering is absolutely homogeneous.

This aim is achieved using a solution with special structuring and shaping of the door uprights, that is to say, the relative section bars, of the coverings and the connecting elements which form the connections between the casing and the set of uprights.

Another aim of the invention is to allow the equally easy and economical production of coverings, whose appearance is homogeneous with those of the uprights, as well as the building wall crosspieces which combine with the former to form the border of the door compartment.

The technical features of the invention, with reference to the above aim, are clearly described in the claims below, in particular claim 1 and in any of the claims directly or indirectly dependent on claim 1.

### BRIEF DESCRIPTION OF THE DRAWINGS

The advantageous aspects of the invention are more apparent from the detailed description which follows, with reference to the accompanying drawings which illustrate preferred embodiments of the invention provided merely by way of example without restricting the scope of the inventive concept, and in which:

FIG. 1 is a schematic elevated view of a building wall incorporating a structure for supporting and concealing a sliding door;

FIG. 2 is a schematic top plan view of the building wall illustrated in FIG. 1 in cross-section according to line II-II;

FIG. 3 is an exploded perspective view of the structure in the building wall for supporting and concealing the sliding door;

FIG. 4 is an enlarged top plan view of several details of the invention illustrated in FIG. 2;

FIG. 5 is a partial cross-section illustrating a detail of the invention according to the line V-V in FIG. 1;

FIG. 6 is a cross-section of a detail of the building wall illustrated in FIG. 1 according to the line VI-VI;

FIG. 7 is an enlarged top plan view of an alternative embodiment of the structure illustrated in FIG. 4, with some parts cut away to better illustrated others;

FIG. 8 is an alternative embodiment of the detail illustrated in FIG. 6;

FIGS. 9 and 10 are respectively a partial cross-section and a detailed view of an alternative embodiment of the invention.

### DESCRIPTION OF THE PREFERRED EMBODIMENTS

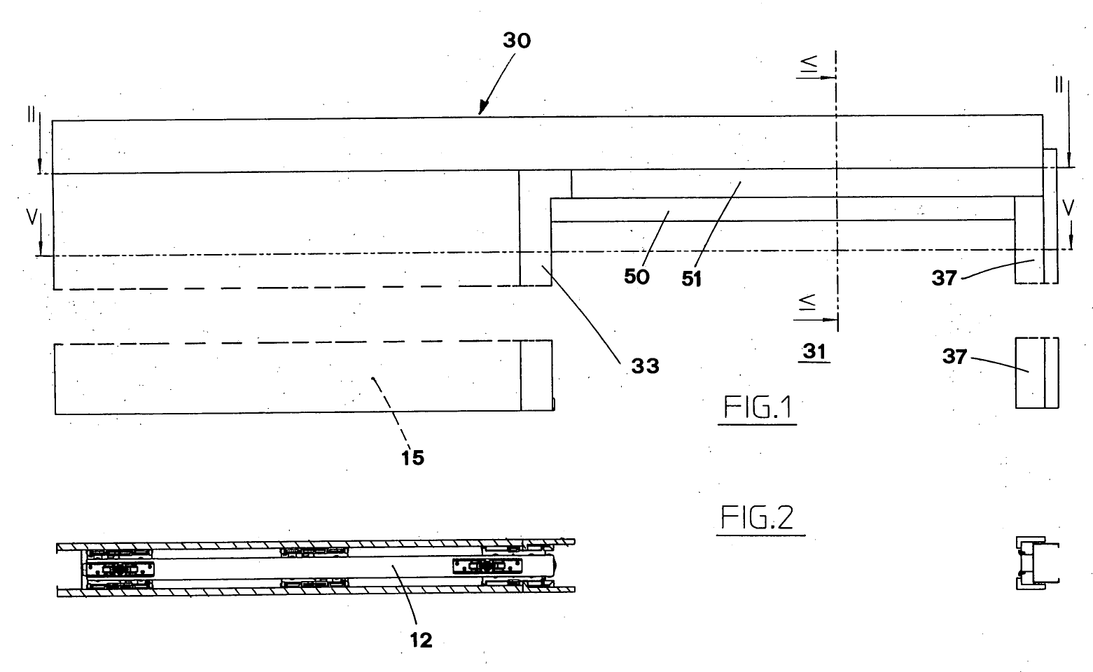

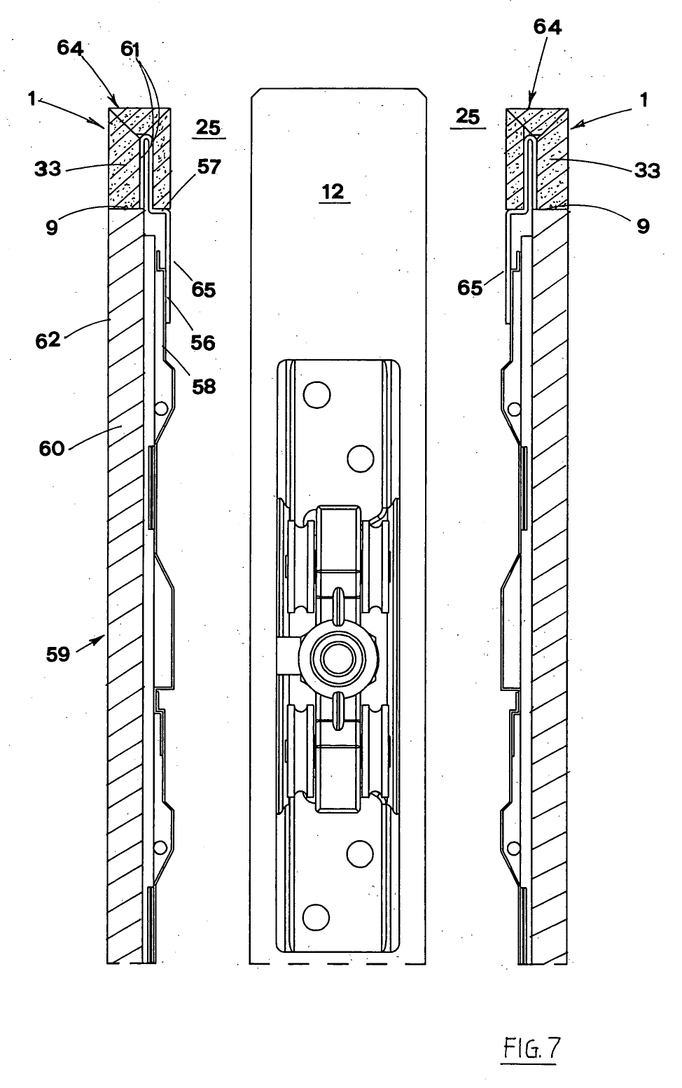

With reference to FIGS. 1 and 2, the numeral 30 denotes as a whole a building wall with a door compartment 31 connected to a structure 15 for slidably supporting and housing a sliding door 12 recessed in the building wall 30. The sliding door is more visible for example in FIGS. 6, 7 and 8.

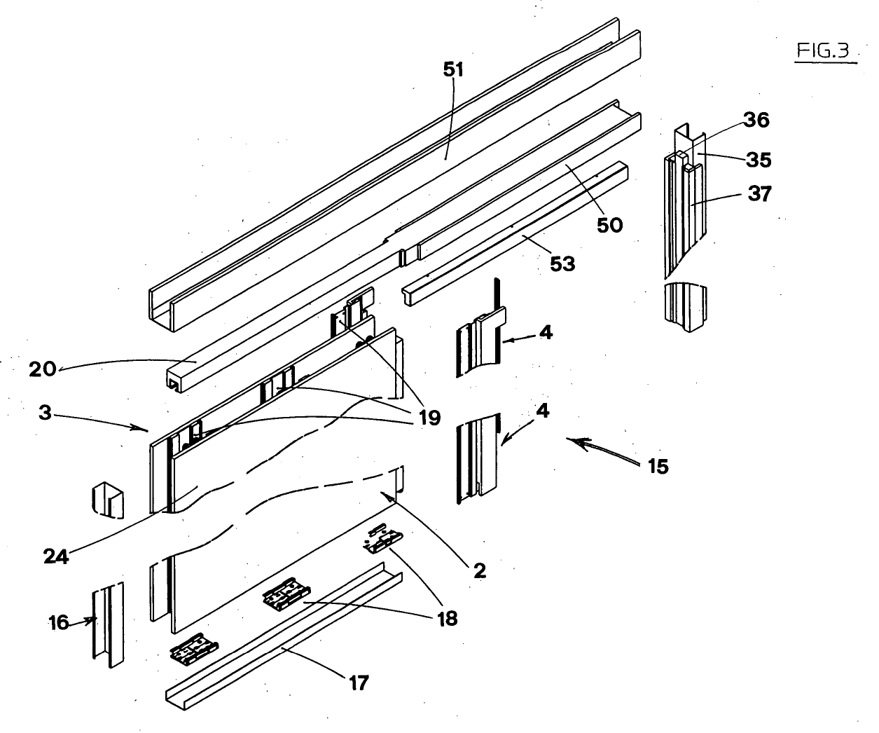

More specifically, FIG. 3 shows how the structure 15 comprises a structural casing 3, made of metal, preferably steel or aluminium.

The casing 3 has a self-supporting structure consisting, in the conventional way, of a plurality of prefabricated metal elements, in particular uprights 4, 16, 19, crosspieces 17 and connecting elements 18.

The prefabricated elements are connected together to form a kind of lattice structure: this is designed to support a track 20 on which the door 12 slides (see also FIG. 6), as well as outer coverings 24, on either side of the casing 3, of wall elements 2, which are joined to the coverings of the general building wall 30 that houses the casing 3.

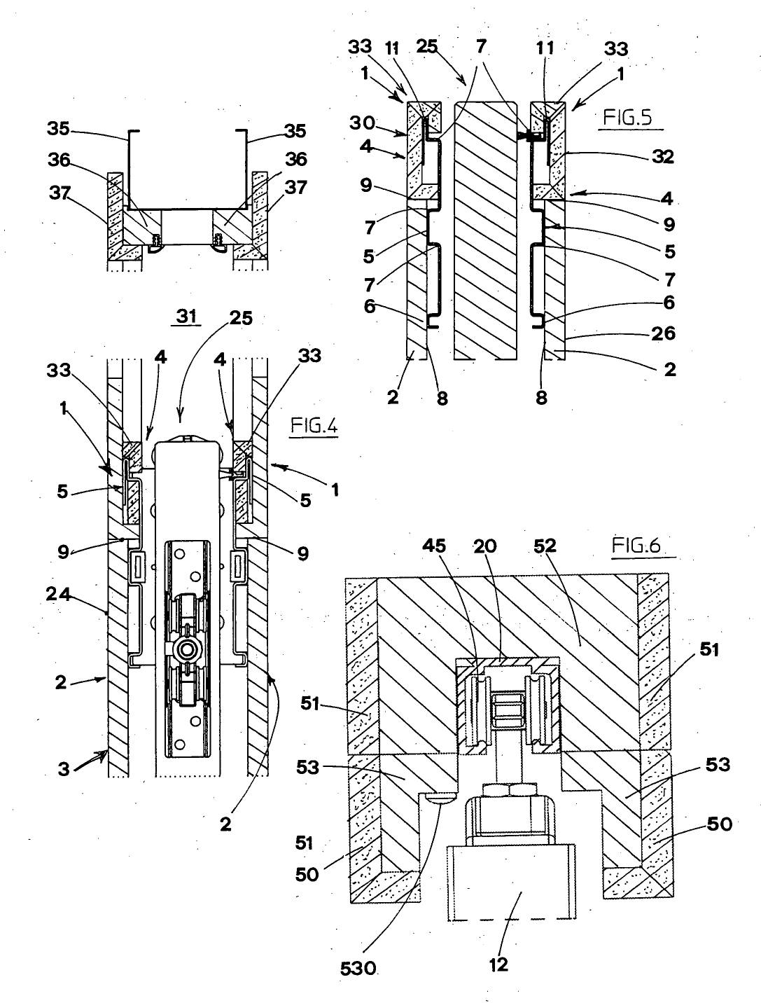

The outer coverings 24 of the casing 3 wall elements 2 are made in the conventional way and may consist for example of preformed panels 24, of the widest and most general kind (for example layered plasterboard elements), panels 24 applied to the casing structural shell and which combined with it define the casing 3 as a whole (FIGS. 3 and 4).

FIGS. 4 and 5 show in particular that the casing 3 includes at each of the wall elements 2 and at the casing 3 entrance opening 25, two structural assemblies, each labelled 1 as a whole, which are the specific subject matter of the present invention.

As illustrated in the accompanying drawings, the assemblies 1 basically comprise two entrance uprights 4, with finishing elements 33 that can be connected to the two sides of the casing 3 entrance opening 25. The entrance uprights 4 are joined to section bars 5 for connecting each upright both to the corresponding casing 3 filling wall elements 2 and to the finishing elements 33.

Each section bar 5 has a shaped, multi-sided outer surface, with a plurality of tabs 6, 7 and 11.

First tabs 6 of the section bar 5 can be connected, so they are flat against it, to a face 8 of a wall element 2 facing the inside of the structural casing 3.

Second tabs 7 of the section bar 5 normally project transversally to the plane in which the door 12 slides.

The second tabs 7 for the end uprights 4 of the structural casing 3 extend parallel with an end surface 9 of the outer covering 24 of the corresponding wall element 2, the end surface 9 in turn being angled so that it is perpendicular to the plane in which the door 12 lies.

The third tabs 11 are designed to anchor each finishing element 33 to the respective section bar 5.

FIG. 5 shows how the second tabs 7 for the end uprights 4, like the third tabs 11 for joining the finishing elements 33 and sections bars 5, remain constantly within the casing 3, inside the relative wall element 2, that is to say, inside the outer edge 26 of the building wall 30.

The finishing elements 33 of the uprights 4 may therefore be shaped in such a way that they can be connected not just to the section bar 5 by the third anchoring tabs 11, but also to the wall elements 2.

The finishing elements 33 are connected to the wall elements 2 by direct contact with at least part of the end surface 9 of the wall element 2, that is to say, with at least part of the outer covering 24. This is clearly illustrated, in particular in FIG. 5, which shows the finishing elements 33 continuing from the wall element 2 and in contact with part of the end surface 9 of the corresponding wall element 2.

Advantageously, this allows the creation on the building wall 30, that is to say, between the wall element 2 and the finishing elements 33 of the uprights 4, of a complete apparent continuity of the outer border. As illustrated in FIGS. 4 and 5, between the outer covering 24 of the wall element 2 and the finishing elements 33 there are none of the parts forming the metal section bar 5, nor are there any metal parts of the section bar 5 projecting towards or beyond the outer edge 26 of the building wall 30.

The finishing elements 33 of the uprights 4 may advantageously have a shaped, multi-sided cross-section extending in a path like a broken line, encompassing the border of the section bar 5.

Such a cross-section may advantageously be obtained using a construction technique for finishing elements 33 known as “folding”.

This technique, described in detail in Italian document IT 1283521, involves the production of finishing elements 33 for walls starting with flat multi-layered panels in which a first flat sheet has a stiffening core layer placed on top of it, upon which in turn one or more surface covering layers are placed, which may finally be folded without damage, to take on the most disparate geometrical shapes.

Therefore, the finishing elements 33 are formed in a sequence of steps which, in brief, include cutting the first flat sheet and the intermediate layer, without affecting the covering layer which is left intact. Then, the first cut sheet is folded at the cuts and the fold line created in the covering layer. A second sheet folded to match the first and comprising at least one surface layer is then glued on top of the first folded sheet.

Using the technology summarised, the entrance uprights 4 can therefore be obtained from a single sheet of composite material, for example plasterboard which is first cut through part of its thickness and then folded without breaking its basic continuity, then covered with and glued to a second surface layer in the final shape required for the covering, that is to say, in a shape which fits the section bar 5 used.

The “folding” technique used to make the finishing elements 33 of the casing 3 entrance 25 uprights 4, can be used not just for these uprights, but also for other parts of the casing 3 and other door compartment accessories 25. It can advantageously be used for covering the parts of the building wall 30 adjacent to the track 20 on which the door 12 slides, as well as for covering and concealing the upright 35 with which the door 12 makes contact.

As regards the upright 35 with which the door makes contact, the above indications are evident in the upper part of FIG. 4.

Said Figure shows how the upright 35 together with the relative door 12 stop elements 36 is joined, along part of its outer sides, to finishing elements 37, substantially L-shaped, also obtained using the “folding” technique.

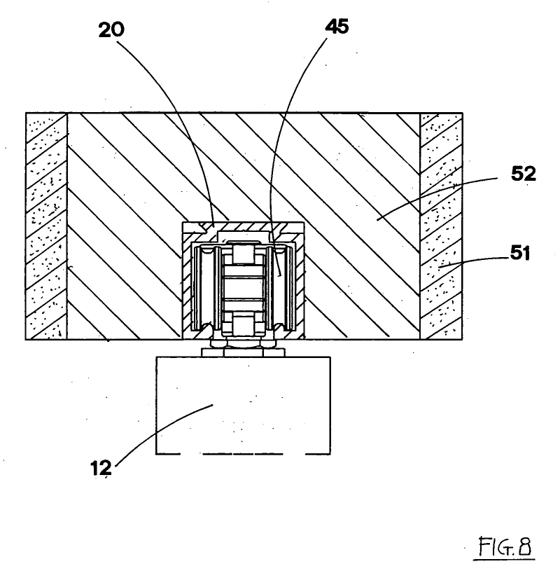

A similar solution may be possible for finishing elements 50 and 5, of part of the building wall 30 above the door 12, which are located on either side of the track 20 on which the door 12 slides and are visible in FIG. 6 and in an alternative embodiment illustrated in FIG. 8.

More particularly, FIG. 6 shows that the track 20 on which the door 12 carriages 45 run is concealed by a containment structure made in two parts 52 and 53 the outside of which is covered with flat finishing elements 51 and with “L”-shaped finishing elements 50, preferably obtained using the “folding” technique. The embodiment in FIG. 8 illustrates a method for hanging the door 12 which is more compact and simple than that in FIG. 6.

To conclude, the use of finishing elements 33, 37, 50 and 51 prefabricated using the “folding” technique and installed on the building wall 30 as a whole, as illustrated in FIG. 1, allows the rapid and economical achievement, with a single construction technology, of building walls 30 which appear homogeneous and uniform over their entire extension, at most requiring only very limited stuccoing of the join lines, which in FIG. 1 are deliberately kept visible purely to allow a better understanding of the invention.

It should also be noticed that forming the finishing elements 33, 37, 50 and 51 using the “folding” technique also allows other advantages to be obtained. These include the advantage of being able to make the building wall 30 above the door compartment 31 easy to inspect, for example for maintenance of the door 12 sliding carriages 45. FIG. 6 shows how access to the carriages 45 can be achieved by simply removing, on one side of the building wall 30, one of the covers 53 on the sides of the carriages 45 together with one of the corresponding parts 52 of the track 20 containment structure (for example, by removing a fixing screw 530 or similar fixing means). Therefore, access to the door 12 sliding carriages 45 can be achieved in this way with an operation that has a minimum impact on the building wall 30 and is easily and rapidly reversed; unlike the current situation in the prior art, where such access is only allowed with an operation that demolishes a significant part of the wall elements 2 joined to the building wall 30, wall elements 2 that are subsequently difficult to restore both in terms of difficult integration in the existing structure, and the cost of performing this work.

FIG. 7 shows an alternative embodiment of a structure for supporting and containing a sliding door 12, in which the structural assemblies 1 are connected to a self-supporting metal casing 59 which in this case is box-shaped, shell-like, with prefabricated sheet metal walls 58 and an undulating or notched profile.

The outside of the casing 59 supports panels 60, for example layered plasterboard panels, designed to reproduce the structural and aesthetic features of a wall element 2 of a conventional building wall 30. The casing 59 has uprights 64 connected to the casing 59 entrance which comprise finishing elements 33 that make contact with the end surfaces 9 of the wall elements 2 incorporating the panels 60; finishing elements 33 connected to the inner wall 58 of the casing 59 by a section bar 65. The section bar has a first tab 56 at a tangent to the inner wall 58 of the casing, a second tab 57 at a right angle to the plane in which the door 12 lies and third tabs 61 for anchoring the finishing element 33.

Again in this case, the section bar 65 is shaped in such a way that it remains constantly contained inside the outer edge 62 of the building wall 30 and inside the wall element 2 panel 60.

Again, the upright 4 finishing element 33 can preferably, but not exclusively, be obtained using the “folding” technique and the methods described above.

Therefore, the embodiment described allows the combination, with the widest freedom of choice, of various types of materials forming the panels 60 and the upright 64 finishing elements 33, without being subject to any type of functional constraint attributable for example to thermal expansion of the metal parts, or the section bars 65 and of the metal walls 58 of the casing 59 which are joined together. FIG. 7 clearly shows how any thermal expansion of the metal parts of the casing 59 is discharged on the undulations in the metal walls 58 and is confined to the casing 59, without affecting the outer covering of the building wall 30, which remains free of the effects of the thermal expansion prevented.

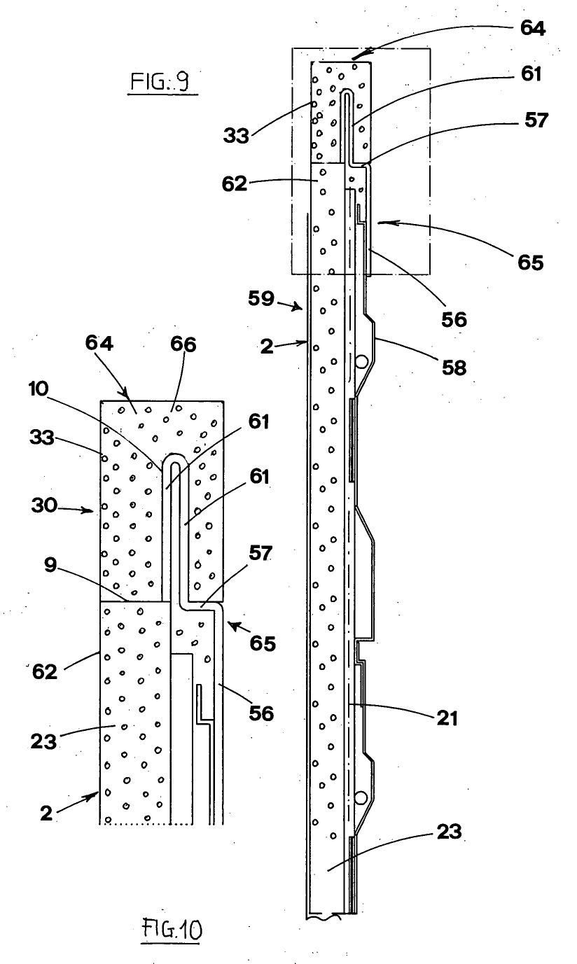

FIGS. 9 and 10 show another alternative embodiment of the structure for supporting and containing the sliding door 12 in which the outside of a casing 59, substantially identical to that in FIG. 7, is covered with a wall element 2 for covering the building wall 30 which is formed directly on the casing 59, after it has been installed.

More specifically, the wall element 2 joined to the building wall 30 covering in this case comprises a layer of plaster 60 which may be anchored to the casing 59 with the aid of a metal mesh 21.

The casing 59 uprights 64 on either side of the casing 59 entrance section 25 comprise finishing elements 33 which make contact with the end surfaces 9 of the layer of plaster 60 of the wall element 2 and connected to the inner wall 58 of the casing 59 by a section bar 65. The section bar has a first tab 56 at a tangent to the wall 58, a second tab 57 at a right angle to the plane in which the door 12 lies and third tabs 61 for anchoring the finishing element 33.

Again, the section bar 65 remains constantly contained inside the outer edge 62 and inside the wall element 2 covering the border of the building wall 30 which as a whole consists of the plaster 60 and the finishing element 33 positioned so that their ends are in contact and continuous with one another.

The upright 64 finishing element 33 may be obtained using the most diverse techniques. As well as the “folding” technique described above, these include the particularly useful and advantageous forming of finishing elements 33 with solid bodies made of a material suitable for joining to a building wall 30 outer covering. In this case, the finishing element 33 has a solid cross-section.

Such finishing elements 33 with a solid body may be made using the most diverse technologies. They may be made of cement designed to adhere without problems to a conventional building wall 30 plaster, with or without the addition of plaster anchoring means, for example metal meshes.

Another technical choice for producing the finishing element 33 may be offered by the possibility of making finishing elements 33 out of solid wood with a rough surface, the level of roughness being suitable to allow a covering cement plaster to be anchored to the finishing element 33.

If the finishing element 33 has a solid body (and, therefore, has a solid cross-section), the finishing element 33 and the section bar 5 and 65 can be anchored by connecting the third tabs 11 and 61 of the section bar 5 and 65 in a corresponding cavity 10 with a matching shape made in the body of the finishing element 33.

As well as giving the appearance of sliding doors that can be recessed into building walls without any masking accessories, the invention disclosed allows this result to be achieved in an easy and economical way with the addition of further advantages regarding the wide freedom of choice and combination of materials used to make the various parts of the casing and the relative coverings; a choice which can be made closely linked to the functions necessitated by the various parts of the structure (purely structural or purely aesthetic, varying from one case to another) without being subject to the constraints between materials that are not always perfectly compatible which arise in the solutions in the prior art.

The invention described has evident industrial applications and can be subject to modifications and variations without thereby departing from the scope of the inventive concept. All the details of the invention may be substituted by technically equivalent elements.

What is claimed:

1) A structural assembly (1) for doors (12) which slide relative to a building wall (30) and can be recessed into a structural casing (3; 59) contained in the building wall (30), said assembly (1) comprising at least one upright (4; 64) which can be connected at least at an entrance opening (25) of the structural casing (3; 59), the upright having at least one section bar (5; 65) for connecting finishing elements (33) to coverings (24; 60; 23) of a casing (3; 59) wall element (2), the section bar (5; 65) having a multi-sided outer surface, with at least two tabs (6; 56; 7; 57), in which a first tab (6; 56) can be connected to a face of the wall element (2), facing towards the inside of the structural casing (3; 59); the assembly (1) further comprising a second tab (7; 57) of the section bar (5; 65) which projects transversally to the plane in which the door (12) slides and parallel with an end surface (9) of the coverings (24; 60; 23) of the wall element (2), remaining confined inside the outer edge (26; 62) of the building wall (30); the upright (4; 64) being shaped in such a way that it can be connected both to the section bar (5; 65) and to part of the end surface (9) of the covering (24; 60; 23), the latter connection involving direct contact between the upright (4; 64) and the end surface (9).

2) The assembly according to claim 1, wherein the one or more finishing elements (33) of the upright (4; 64) at the entrance opening (25) has a shaped, multi-sided cross-section with sides in succession along a broken line.

3) The assembly according to claim 2, wherein the multi-sided cross-section of the finishing element (33) is obtained from a single sheet of multi-layered material, cut through part of its thickness then folded without breaking its basic continuity into the desired configuration.

4) The assembly according to claim 3, wherein the finishing element (33) is obtained from a multi-layered sheet of plasterboard.

5) The assembly according to claim 1, wherein the finishing element (33) is made of a material compatible with the material used to make the wall (2) of the casing (3; 59).

6) The assembly according to claim 3, wherein the finishing element (33) is made of a material with a thermal expansion coefficient compatible with that of the wall (2).

7) The assembly according to claim 1, wherein the length of the second tab (7; 57) of the section bar (5; 65) is less than the thickness of the wall (2), the upright (4; 64) being shaped in such a way that it is in direct contact with the part of the end surface (9) not covered by the second tab (7; 57).

8) The assembly according to claim 7, wherein the second tab (7; 57) of the section bar (5; 65) is at a tangent to the end surface (9).

9) The assembly according to claim 1, wherein the one or more uprights (4; 64) include a finishing element (33) with a solid cross-section.

10) The assembly according to claim 9, wherein the finishing element (33) and the section bar (5; 65) have connecting elements (10; 11; 61) with connecting surfaces that penetrate one another.

11) The assembly according to claim 10, wherein a first connecting element consists of a cavity (10) in the finishing element (33) and a second connecting element includes at least a third tab (11; 61) of the section bar (5) which can be inserted in and anchored with the cavity (10) in the finishing element (33).

12) The assembly according to claim 9, wherein the finishing element (33) and the section bar (5; 65) are joined together to form a single block.

13) The assembly according to claim 1, wherein the finishing element (33) and the section bar (5; 65) are made of different materials.

14) A building wall (30) comprising in combination a contact upright (35) fitted with finishing elements (37) and a structural assembly (1) for doors (12) which slide relative to the building wall (30) and can be recessed into a structural casing (3; 59) contained in the building wall (30), said assembly (1) comprising at least one upright (4; 64) which can be connected at least at an entrance opening (25) of the structural casing (3; 59), the upright having at least one section bar (5; 65) for connecting finishing elements (33) to coverings (24; 60; 23) of a casing (3; 59) wall element (2), the section bar (5; 65) having a multi-sided outer surface, with at least two tabs (6; 56; 7; 57), in which a first tab (6; 56) can be connected to a face of the wall element (2), facing towards the inside of the structural casing (3; 59); the assembly (1) further comprising a second tab (7; 57) of the section bar (5; 65) which projects transversally to the plane in which the door (12) slides and parallel with an end surface (9) of the coverings (24; 60; 23) of the wall element (2), remaining confined inside the outer edge (26; 62) of the building wall (30); the upright (4; 64) being shaped in such a way that it can be connected both to the section bar (5; 65) and to part of the end surface (9) of the covering (24; 60; 23), the latter connection involving direct contact between the upright (4; 64) and the end surface (9).

15) A building wall (30) according to claim 14, in which part of the building wall (30) over a door compartment (31) is fitted with outer finishing elements (50, 51).

16) The building wall according to claim 14, characterised in that the finishing elements (33; 37) are obtained from a single sheet of multi-layered material, which is first cut through part of its thickness and then folded without breaking its basic continuity into the desired configuration.

17) The building wall according to claim 15, characterised in that the finishing elements (33; 37; 50; 51) are obtained from a single sheet of multi-layered material, which is first cut through part of its thickness and then folded without breaking its basic continuity into the desired configuration.

18) The building wall according to claim 16, characterised in that the finishing elements (33; 37) are obtained from a multi-layered sheet of plasterboard.

19) The building wall according to claim 17, characterised in that the finishing elements (33; 37; 50; 51) are obtained from a multi-layered sheet of plasterboard.

20) A building wall (30) in which part of the building wall (30) over a door compartment (31) is fitted with outer finishing elements (50, 51), the building wall (30) comprising a structural assembly (1) for doors (12) which slide relative to the building wall (30) and can be recessed into a structural casing (3; 59) contained in the building wall (30), said assembly (1) comprising at least one upright (4; 64) which can be connected at least at an entrance opening (25) of the structural casing (3; 59), the upright having at least one section bar (5; 65) for connecting finishing elements (33) to coverings (24; 60; 23) of a casing (3; 59) wall element (2), the section bar (5; 65) having a multi-sided outer surface, with at least two tabs (6; 56; 7; 57), in which a first tab (6; 56) can be connected to a face of the wall element (2), facing towards the inside of the structural casing (3; 59); the assembly (1) further comprising a second tab (7; 57) of the section bar (5; 65) which projects transversally to the plane in which the door (12) slides and parallel with an end surface (9) of the coverings (24; 60; 23) of the wall element (2), remaining confined inside the outer edge (26; 62) of the building wall (30); the upright (4; 64) being shaped in such a way that it can be connected both to the section bar (5; 65) and to part of the end surface (9) of the covering (24; 60; 23), the latter connection involving direct contact between the upright (4; 64) and the end surface (9).

21) The building wall according to claim 20, characterised in that the finishing elements (33; 50; 51) are obtained from a single sheet of multi-layered material, which is first cut through part of its thickness and then folded without breaking its basic continuity into the desired configuration.

22) The building wall according to claim 17, characterised in that the finishing elements (33; 50; 51) are obtained from a multi-layered sheet of plasterboard.
